(19) United States
(12) Patent Application Publication
(10) Pub. No.: US 2024/0064458 A1
(43) Pub. Date: Feb. 22, 2024

(54) MOLECULAR SIEVE SOUND-ABSORBING MATERIAL, METHOD FOR PREPARING THE SAME AND SPEAKER

(71) Applicant: AAC Microtech (Changzhou) Co., Ltd., Changzhou City (CN)

(72) Inventors: Jie Zhang, Shenzhen (CN); Hezhi Wang, Shenzhen (CN); Zhongyang Wang, Shenzhen (CN)

(21) Appl. No.: 18/094,992

(22) Filed: Jan. 10, 2023

Related U.S. Application Data
(63) Continuation of application No. PCT/CN2022/122004, filed on Sep. 28, 2022.

(30) Foreign Application Priority Data
Aug. 19, 2022 (CN) 202211000387.1

(51) Int. Cl. H04R 1/28; C01B 39/54; C08K 3/32; C08J 3/205; H04R 1/02

(52) U.S. Cl. CPC H04R 1/288; C01B 39/54; C08K 3/32; C08J 3/2053; H04R 1/025; C08K 2003/327; C08J 2333/04

(57) ABSTRACT

A molecular sieve sound-absorbing material, a method for preparing the same, and a speaker. The sound-absorbing material includes a modifying molecular sieve and a binder, the mass of the binder accounts for 2% to 10% of the mass of the modifying molecular sieve, the modifying molecular sieve is obtained by performing phosphorus modification on a molecular sieve, a mass ratio of silicon to aluminum in the molecular sieve is (50-800):1, and a molar ratio of phosphorus to aluminum in the modifying molecular sieve is (0.1-2):1. The sound-absorbing material includes a phosphorus-modifying molecular sieve. Application of the modifying molecular sieve to the sound-absorbing material can ensure that the sound-absorbing material can also maintain good sound absorption performance under high-temperature and high-humidity conditions.

### TECHNICAL FIELD

The present disclosure relates to the technical field of materials, and in particular, to a molecular sieve sound-absorbing material, a method for preparing the molecular sieve sound-absorbing material and a speaker.

### BACKGROUND

With the continuous development of portable electronic devices such as smart phones and Bluetooth headsets, people have higher and higher requirements for audio quality. In order to improve the audio quality and improve a sound effect of a speaker, one of the common methods used at present is to load a sound-absorbing material into a rear cavity of the speaker to increase a volume of a virtual rear cavity, so as to improve the audio quality.

As a high specific surface area material, a molecular sieve can constantly adsorb and desorb air in a cavity when the cavity vibrates, so as to indirectly achieve an effect of increasing a volume of the cavity, which is therefore a common sound-absorbing material in the rear cavity of the speaker. However, due to long-term operation in high-temperature and high-humidity environments, the speaker may have reduced sound quality and even produce noise. This is because the molecular sieve, especially the molecular sieve with a low silica to alumina ratio, is prone to irreversible inactivation under high-temperature and high-humidity conditions, which causes an F₀ value to be higher and then lowers the sound quality or produces noise.

Therefore, there is a need to develop a molecular sieve sound-absorbing material with excellent reliability in high-temperature and high-humidity environments.

### SUMMARY

The present disclosure provides a molecular sieve sound-absorbing material, a method for preparing the molecular sieve sound-absorbing material, and a speaker, so as to solve the problem that sound-absorbing materials for existing speakers are prone to irreversible inactivation under high-temperature and high-humidity conditions, which causes an F₀ value to be higher and then lowers the sound quality or produces noise.

According to a first aspect of the present disclosure, the present disclosure provides a molecular sieve sound-absorbing material. The sound-absorbing material includes a modifying molecular sieve and a binder. The mass of the binder accounts for 2% to 10% of the mass of the modifying molecular sieve. The modifying molecular sieve is obtained by performing phosphorus modification on a molecular sieve. A mass ratio of silicon to aluminum in the molecular sieve is (50-800):1, and a molar ratio of phosphorus to aluminum in the modifying molecular sieve is (0.1-2):1.

As an improvement, a phosphorus source used in the phosphorus modification is one or more of phosphoric acid, ammonium phosphate, and ammonium hydrogen phosphate.

As an improvement, the binder is one or more of polyacrylate, polystyrene acrylate, polystyrene acetate, polyurethane resin, and polyethyl vinyl acetate.

As an improvement, the molecular sieve has one or more structure types of MFI, FER, and MEL.

According to a first aspect of the present disclosure, the present disclosure provides a method for preparing the sound-absorbing material mentioned above. The method includes following steps:
step S1: mixing a molecular sieve uniformly with water to obtain a molecular sieve slurry;
step S2: adding a phosphorus source to the molecular sieve slurry obtained in step S1 for, undergoing ultrasonic impregnation by an ultrasonic microwave impregnation method to obtain an impregnated solution; and filtering the an impregnated solution to obtain a filter cake, and taking the a filter cake for drying and grinding to obtain intermediate molecular sieve powder;
step S3: calcining the intermediate molecular sieve powder obtained in step S2 to obtain a modifying molecular sieve;
step S4: mixing the modifying molecular sieve obtained in step S3 uniformly with water, and then adding a binder thereto to obtain a suspension; and
step S5: molding and drying the suspension to obtain the molecular sieve sound-absorbing material.

As an improvement, in step S1, a weight to volume ratio of the molecular sieve to the water is (10 to 30):(150 to 250).

As an improvement, in step S2, an ultrasonic device used in the ultrasonic microwave impregnation method is probe ultrasound; a microwave heating temperature of the ultrasonic microwave impregnation method ranges from 60° C. to 90° C.; and ultrasonic impregnation time of the ultrasonic microwave impregnation method ranges from 0.5 h to 2 h.

As an improvement, in step S4, a weight ratio of the modifying molecular sieve, the water to the binder is 1:(0.6 to 1.5):(0.02 to 0.10).

As an improvement, in step S5, the drying comprises one or more of freeze drying, vacuum drying, and ambient pressure drying.

According to a third aspect of the present disclosure, the present disclosure provides a speaker. The speaker includes a housing with a receiving space, a sound-producing unit arranged in the housing, and a rear cavity enclosed by the sound-producing unit and the housing. The rear cavity is filled with the sound-absorbing material mentioned above.

The present disclosure has the following beneficial effects:

In the present disclosure, a molecular sieve sound-absorbing material includes a modifying molecular sieve. The modifying molecular sieve is obtained by performing phosphorus modification on a molecular sieve. Phosphorus enters into a framework of the molecular sieve and bonds with silicon and aluminum in the framework to form P—O—Si and P—O—Al structures, which can enhance stability of the framework of the molecular sieve, so that the obtained modifying molecular sieve has a more stable framework structure, and has better resistance to water vapor hydrolysis at high temperatures. Disclosure of the modifying molecular sieve to the sound-absorbing material can ensure that the sound-absorbing material can also maintain good sound absorption performance under high-temperature and high-humidity conditions. The molar ratio of phosphorus to aluminum in the modifying molecular sieve is limited to (0.1-2):1, so that the obtained modifying molecular sieve has a more stable framework, and has better resistance to water vapor hydrolysis at high temperatures, and thus can ensure sound absorption performance of the sound-absorbing material more effectively. If the modifying molecular sieve has too little phosphorus to form enough coordination bonds, the framework of the molecular sieve cannot be effectively protected. When the content of phosphorus in the framework is high, the phosphorus species may block pores of the molecular sieve, affecting adsorption capability of the molecular sieve to gas. The present disclosure further defines the mass ratio of silicon to aluminum in the molecular sieve. A reasonable mass ratio of silicon to aluminum can ensure the stability of the framework structure of the molecular sieve, and thus the stability of the framework structure of the modifying molecular sieve is ensured. The sound-absorbing material of the present disclosure further includes a binder. A purpose of adding the binder to the sound-absorbing material is to increase viscosity of the molecular sieve slurry so as to better form spherical particles. In the present disclosure, it is defined that the mass of the binder accounts for 2% to 10% of the mass of the modifying molecular sieve, which can ensure the viscosity of the molecular sieve slurry so as to better form the spherical particles. The sound-absorbing material of the present disclosure can be used for a long time under conditions of a temperature ranging from 50° C. to 150° C. and humidity ranging from 60% rh to 100% rh, whose performance is obviously better than that of an unmodifying molecular sieve sound-absorbing material.

### BRIEF DESCRIPTION OF DRAWINGS

FIG. 1 is a schematic diagram of an internal structure of a speaker according to the present disclosure; and

FIG. 2 is a comparison diagram of high-temperature and high-humidity test results continuously monitored for 5 days according to Embodiment 1 and Comparative Example 1 of the present disclosure.

### REFERENCE SIGNS

1: housing;
2: sound-producing unit;
3: rear cavity;
10: speaker.

The accompanying drawings herein are incorporated in and constitute a part of this specification, illustrate embodiments consistent with the present disclosure and, together with the description, serve to explain the principles of the present disclosure.

### DESCRIPTION OF EMBODIMENTS

In order to better understand the technical solution of the present disclosure, Examples of the present disclosure are described in detail below with reference to the accompanying drawings.

It should be made clear that the embodiments described are only some rather than all of the embodiments of the present disclosure. All other embodiments acquired by those of ordinary skill in the art without creative efforts based on the embodiments in the present disclosure fall within the protection scope of the present disclosure.

The terms used in the embodiments of the present disclosure are intended only to describe particular embodiments and are not intended to limit the present disclosure. As used in the embodiments of the present disclosure and the appended claims, the singular forms of “a/an”, “said”, and “the” are intended to include plural forms, unless otherwise clearly specified by the context.

It is to be understood that the term “and/or” used herein is merely an association relationship describing associated objects, indicating that three relationships may exist. For example, A and/or B indicates that there are three cases of A alone, A and B together, and B alone. In addition, the character “/” herein generally means that associated objects before and after it are in an “or” relationship.

It is to be noted that the location terms such as “upper”, “lower”, “left”, and “right” described in the embodiments of the present disclosure are described with reference to the angles shown in the accompanying drawings, and should not be construed as limitations on the embodiments of the present disclosure. In addition, in the context, it is to be further understood that, when one element is referred to as being connected “above” or “below” another element, the one element may be directly connected “above” or “below” the another element, or connected “above” or “below” the another element via an intermediate element.

In a first aspect, the present disclosure provides a molecular sieve sound-absorbing material. The sound-absorbing material includes a modifying molecular sieve and a binder, the mass of the binder accounts for 2% to 10% of the mass of the modifying molecular sieve, the modifying molecular sieve is obtained by performing phosphorus modification on a molecular sieve, a mass ratio of silicon to aluminum in the molecular sieve is (50-800):1, and a molar ratio of phosphorus to aluminum in the modifying molecular sieve is (0.1-2):1.

In some embodiments, a percentage of the mass of the binder in the mass of the modifying molecular sieve may be 2%, 3%, 4%, 5%, 6%, 7%, 8%, 9% or 10%, etc., which may certainly also be other values in the above range, and is not limited herein. The binder may be selected from one or more of polyacrylate, polystyrene acrylate, polystyrene acetate, polyurethane resin, and polyethyl vinyl acetate. Solid content of the binder may range from 35% to 60%, and may specifically be 35%, 40%, 45%, 50%, 55% or 60%, etc., which may certainly also be other values in the above range, and is not limited herein.

In some embodiments, the mass ratio of silicon to aluminum in the molecular sieve may be 50:1, 100:1, 200:1, 300:1, 400:1, 500:1, 600:1, 700:1 or 800:1, etc., which may certainly also be other values in the above range, and is not limited herein.

In some embodiments, the molar ratio of phosphorus to aluminum in the modifying molecular sieve may be 0.1:1, 0.25:1, 0.5:1, 0.75:1, 1:1, 1.25:1, 1.5:1, 1.75:1 or 2:1, etc., which may certainly also be other values in the above range, and is not limited herein. Preferably, the molar ratio of phosphorus to aluminum in the modifying molecular sieve is (0.5-1.5):1.

In the above solution, the sound-absorbing material includes a modifying molecular sieve. The modifying molecular sieve is obtained by performing phosphorus modification on a molecular sieve. Phosphorus enters into a framework of the molecular sieve and bonds with silicon and aluminum in the framework to form P—O—Si and P—O—Al structures, which can enhance stability of the framework of the molecular sieve, so that the obtained modifying molecular sieve has a more stable framework structure, and has better resistance to water vapor hydrolysis at high temperatures. Disclosure of the modifying molecular sieve to the sound-absorbing material can ensure that the sound-absorbing material can also maintain good sound absorption performance under high-temperature and high-humidity conditions. The molar ratio of phosphorus to aluminum in the modifying molecular sieve is limited to (0.1-2):1, so that the obtained modifying molecular sieve has a more stable framework, and has better resistance to water vapor hydrolysis at high temperatures, and thus can ensure sound absorption performance of the sound-absorbing material more effectively. If the modifying molecular sieve has too little phosphorus to form enough coordination bonds, the framework of the molecular sieve cannot be effectively protected. When the content of phosphorus in the framework is high, the phosphorus species may block pores of the molecular sieve, affecting adsorption capability of the molecular sieve to gas. The present disclosure further defines the mass ratio of silicon to aluminum in the molecular sieve. A reasonable mass ratio of silicon to aluminum can ensure the stability of the framework structure of the molecular sieve, and thus the stability of the framework structure of the modifying molecular sieve is ensured. The sound-absorbing material of the present disclosure further includes a binder. A purpose of adding the binder to the sound-absorbing material is to increase viscosity of the molecular sieve slurry so as to better form spherical particles. In the present disclosure, it is defined that the mass of the binder accounts for 2% to 10% of the mass of the modifying molecular sieve, which can ensure the viscosity of the molecular sieve slurry so as to better form the spherical particles. The sound-absorbing material of the present disclosure can be used for a long time under conditions of a temperature ranging from 50° C. to 150° C. and humidity ranging from 60% rh to 100% rh, whose performance is obviously better than that of an unmodifying molecular sieve sound-absorbing material.

As an optional technical solution of the present disclosure, a phosphorus source used in the phosphorus modification is one or more of phosphoric acid, ammonium phosphate, and ammonium hydrogen phosphate, which is certainly not limited to such phosphorus sources.

As an optional technical solution of the present disclosure, the binder is one or more of polyacrylate, polystyrene acrylate, polystyrene acetate, polyurethane resin, and polyethyl vinyl acetate.

As an optional technical solution of the present disclosure, the molecular sieve has one or more of MFI, FER, and MEL structure types.

Understandably, through the specific limitations on the type of the phosphorus source, the type of the binder, and the structure of the molecular sieve, a better synergistic effect can be achieved among raw materials for the preparation of the sound-absorbing material, so that the sound-absorbing material can maintain better sound absorption performance under high-temperature and high-humidity conditions.

In a second aspect, the present disclosure further provides a method for preparing the sound-absorbing material described above. The preparation method includes the following steps:
In step S1, a molecular sieve is mixed uniformly with water to obtain a molecular sieve slurry.
In step S2, a phosphorus source is added to the molecular sieve slurry obtained in step S1 for ultrasonic impregnation by an ultrasonic microwave impregnation method to obtain an impregnated solution. The impregnated solution is filtered to obtain a filter cake, and the filter cake is taken for drying and grinding to obtain intermediate molecular sieve powder.
In step S3, the intermediate molecular sieve powder obtained in step S2 is calcined to obtain a modifying molecular sieve.
In step S4, the modifying molecular sieve obtained in step S3 is mixed uniformly with water, and then a binder is added thereto to obtain a suspension.
In step S5, the suspension is molded and dried to obtain the molecular sieve sound-absorbing material.

In some embodiments, in step S2, filtering an impregnated solution, and taking a filter cake therefrom for drying may involve the following specific steps: sucking and filtering the impregnated solution, repeatedly cleaning and filtering filtered solids with deionized water, and then drying the filtered solids in an oven at 120° C.

In some embodiments, the suspension may be treated by selecting a corresponding molding means according to a specific use requirement to obtain the sound-absorbing material in a final form. The molding method includes, but is not limited to, obtaining a high-temperature and high-humidity resistant granular sound-absorbing material by drying after spraying or granulation in other means; obtaining a high-temperature and high-humidity resistant blocky sound-absorbing material by drying after molding through a specific die; obtaining a high-temperature and high-humidity resistant foam-type sound-absorbing material by drying after loading the suspension on porous materials, for example, organic foam, activated carbon foam, and other materials; and obtaining a sheet-like or film-like sound-absorbing material by coating or printing.

In the above solution, a modified method of phosphorus impregnation for the molecular sieve is an ultrasonic microwave impregnation method. Ultrasonic impregnation has a better dispersion effect than conventional impregnation due to ultrasonic cavitation, and phosphorus is more uniformly dispersed in the framework of the molecular sieve. Compared with conventional water bath heating, microwave heating has better heat conduction efficiency and heating uniformity due to a dielectric heating effect and deep penetration.

As an optional solution of the present disclosure, in step S1, a weight to volume ratio of the molecular sieve to the water is (10-30):(150-250). It is to be noted that the weight to volume ratio means that the water is measured in milliliters when the molecular sieve is measured in grams.

In some embodiments, the weight to volume ratio of the molecular sieve to the water may be 10:150, 10:200, 10:250, 20:150, 20:200, 20:250, 30:150, 30:200 or 30:250, etc., which may certainly also be other values in the above range, and is not limited herein. Understandably, through the limitation on the weight to volume ratio of the molecular sieve to the water, the molecular sieve slurry at appropriate concentration can be obtained, so as to facilitate a subsequent phosphorus modification step.

As an optional solution of the present disclosure, in step S2, an ultrasonic device used in the ultrasonic microwave impregnation method is probe ultrasound. A microwave heating temperature of the ultrasonic microwave impregnation method ranges from 60° C. to 90° C. Ultrasonic impregnation time of the ultrasonic microwave impregnation method ranges from 0.5 h to 2 h.

In some embodiments, the microwave heating temperature of the ultrasonic microwave impregnation method may be 60° C., 65° C., 70° C., 75° C., 80° C., 85° C. or 90° C., etc., which may certainly also be other values in the above range, and is not limited herein.

In some embodiments, the ultrasonic impregnation time of the ultrasonic microwave impregnation method may be 0.5 h, 0.8 h, 1 h, 1.2 h, 1.5 h, 1.8 h or 2 h, etc., which may certainly also be other values in the above range, and is not limited herein.

Understandably, through the limitations on the ultrasonic device, the microwave heating temperature, and the ultrasonic impregnation time selected in the ultrasonic microwave impregnation method, phosphorus can be more uniformly dispersed in the framework of the molecular sieve, thereby improving dispersion efficiency.

As an optional solution of the present disclosure, in step S3, the calcining is at a temperature ranging from 400° C. to 600° C.

In some embodiments, the temperature of the calcining may be 400° C., 420° C., 450° C., 480° C., 500° C., 550° C., 580° C. or 600° C., etc., which may certainly also be other values in the above range, and is not limited herein.

As an optional solution of the present disclosure, in step S3, time of the calcining ranges from 0.5 h to 1.5 h.

In some embodiments, the time of the calcining may be 0.5 h, 0.6 h, 0.7 h, 0.8 h, 0.9 h, 1.0 h, 1.1 h, 1.2 h, 1.3 h, 1.4 h or 1.5 h, etc., which may certainly also be other values in the above range, and is not limited herein.

Understandably, through the limitations on the temperature and the time of the calcining, a modifying molecular sieve with a stable structure can be obtained.

In some embodiments, in step S5, molding the suspension specifically includes the following steps: dispersing the suspension into droplets of a uniform size through a granulating device, and then feeding the droplets into a cooling tower and freezing the droplets into solid particles a. A microspherical sound-absorbing material can be obtained after the molding.

In some embodiments, in step S5, molding the suspension specifically includes the following steps: first filtering the suspension with a filter screen to remove undispersed large particles, dispersing the suspension into droplets of a uniform size through a granulating device, and then feeding the droplets into a cooling tower and freezing the droplets into solid particles a. A microspherical sound-absorbing material can be obtained after the molding.

In some embodiments, in step S5, molding the suspension specifically includes the following steps: first filtering the suspension with a filter screen to remove undispersed large particles, and then putting the suspension into a forming die for molding. A blocky sound-absorbing material can be obtained after the molding.

In some embodiments, in step S5, molding the suspension specifically includes the following steps: first filtering the suspension with a filter screen to remove undispersed large particles, and then immersing the suspension in a porous material. The porous material may be organic foam, carbon fiber foam, or the like. A foam-type sound-absorbing material can be obtained after the molding.

As an optional technical solution of the present disclosure, in step S4, a weight ratio of the modifying molecular sieve, the water to the binder is 1: (0.6-1.5):(0.02-0.10).

As an optional technical solution of the present disclosure, in step S5, the drying includes one or more of freeze drying, vacuum drying, and ambient pressure drying.

In some embodiments, the drying involves the following specific steps: putting frozen solid particles a into a frozen drying oven to be dried for 12 h, and obtaining solid particles b after sublimation of all ice in the particles; and putting the solid particles b into the oven to be dried for 2 h at 100° C. to 150° C.

In some embodiments, the drying involves the following specific steps: putting frozen solid particles a into a vacuum drying oven to be dried for 12 h at −40° C., and putting dried particles in the oven to be dried for 2 h at 110° C.

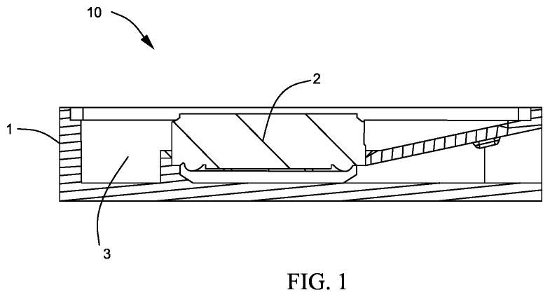

In a third aspect, the present disclosure further provides a speaker. As shown in FIG. 1, a speaker 10 includes a housing 1 with a receiving space, a sound-producing unit 2 arranged in the housing 1, and a rear cavity 3 enclosed by the sound-producing unit 2 and the housing 1; the rear cavity 3 being filled with the sound-absorbing material described above in the present disclosure.

Understandably, a resonant cavity of the speaker is filled with the sound-absorbing material described above in the present disclosure, which can adapt to high-temperature and high-humidity environments. Such a speaker is applicable to electronic devices such as smart watches, phones, tablet computers, headphones, smart stereos and notebook computers.

The embodiments of the present disclosure are further described below with multiple embodiments. The embodiments of the present disclosure are not limited to the following specific embodiments. Within the scope of protection, changes can be implemented appropriately.

### Example 1

A method for preparing a molecular sieve sound-absorbing material is performed according to the following steps:

In step S1, 20 g of ZSM-5(MFI) zeolite was weighed and added to 200 ml of deionized water, which were stirred uniformly to obtain a molecular sieve slurry.

In step S2, (NH₄)₂HPO₄ with a molar ratio of 1:1 to Al in ZSM-5(MFI) zeolite was weighed and added to the molecular sieve slurry, which underwent ultrasonic impregnation for 1 h under microwave heating at 80° C.

An impregnated solution was filtered, and a filter cake was taken and repeatedly cleaned with the deionized water and then was dried in an oven at 120° C.

In step S3, solids obtained in step S2 were calcined in a Muffle furnace for 1 h at 500° C. and then taken out and ground into powder to obtain a modifying molecular sieve.

In step S4, 20 g of the modifying molecular sieve, 20 g of deionized water, 2 g of acrylic adhesive were weighed, mixed evenly, and stirred at room temperature for 2 h to obtain a suspension.

In step S5, the suspension obtained in step S4 was dispersed into small droplets of a uniform size through a granulating device, and the droplets entered a cooling tower and were frozen into solid particles.

The solid particles were put into a vacuum drying oven and dried for 12 h at −40° C., and dried particles were put into the oven and dried for 2 h at 110° C. Resulting solid particles are a high-temperature and high-humidity resistant molecular sieve sound-absorbing microsphere material.

### Comparative Example 1

Different from Example 1, steps S1 to S3 are omitted in this comparative example, and unmodified ZSM-5(MFI) molecular sieve powder was directly used to prepare sound-absorbing microspheres.

### Experiment Example

1. Acoustic Measurement

A resonant frequency of a speaker was determined by measuring frequency dependent resistance and a phase thereof, as well as a corresponding zero crossing point thereof. A speaker with a rear cavity of 0.5 ml and a sound-producing unit of 11 mm*15 mm*3 mm was connected to an impedance analyzer. Microspheres with diameters ranging from 300 μm to 350 μm were screened to fill the rear cavity of the speaker. Compared with an empty cavity, an offset value of F₀, that is, an F₀ value, was calculated.

2. High-Temperature and High-Humidity Test

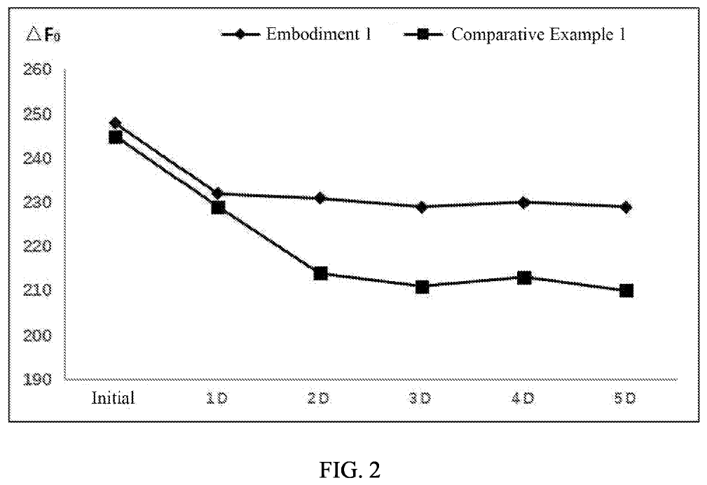

According to Example 1 and Comparative Example 1 of the present disclosure, after an initial performance test, the molecular sieve sound-absorbing microspheres were placed in a high-temperature and high-humidity chamber at 85° C./85% rh, and were taken out every 24 h and placed at room temperature for 1 h before F₀ was measured. High-temperature and high-humidity test results continuously monitored for 5 days are shown in FIG. 2.

As can be seen from FIG. 2, performance of the molecular sieve sound-absorbing microspheres after phosphorus modification was no longer significantly degraded after being placed in a high-temperature and high-humidity environment for more than 1 day, while performance loss of the molecular sieve sound-absorbing microspheres without phosphorus modification was double that of the former after being placed in the high-temperature and high-humidity environment for more than 1 day. The results show that the modifying molecular sieve sound-absorbing material has better high-temperature and high-humidity resistance.

The above are only preferred embodiments of the present disclosure and are not intended to limit the present disclosure. For those skilled in the art, the present disclosure may be subject to various modifications and changes. Any modification, equivalent replacement, improvement and the like within the spirit and principle of the present disclosure all fall within the protection scope of the present disclosure.

What is claimed is:

1. A molecular sieve sound-absorbing material, comprising a modifying molecular sieve and a binder, the binder accounts for 2% to 10% by mass of the modifying molecular sieve, the modifying molecular sieve is obtained by performing phosphorus modification on a molecular sieve, a mass ratio of silicon to aluminum in the molecular sieve is (50 to 800):1, and a molar ratio of phosphorus to aluminum in the modifying molecular sieve is (0.1 to 2):1.

2. The molecular sieve sound-absorbing material as described in claim 1, wherein a phosphorus source used in the phosphorus modification is one or more of phosphoric acid, ammonium phosphate, and ammonium hydrogen phosphate.

3. The molecular sieve sound-absorbing material as described in claim 1, wherein the binder is one or more of polyacrylate, polystyrene acrylate, polystyrene acetate, polyurethane resin, and polyethyl vinyl acetate.

4. The molecular sieve sound-absorbing material as described in claim 1, wherein the molecular sieve has one or more structure types of MFI, FER, and MEL.

5. A method for preparing a sound-absorbing material as described in claim 1, comprising following steps:
step S1: mixing a molecular sieve uniformly with water to obtain a molecular sieve slurry;
step S2: adding a phosphorus source to the molecular sieve slurry obtained in step S1 for, undergoing ultrasonic impregnation by an ultrasonic microwave impregnation method to obtain an impregnated solution; and filtering the an impregnated solution to obtain a filter cake, and taking the a filter cake for drying and grinding to obtain intermediate molecular sieve powder;
step S3: calcining the intermediate molecular sieve powder obtained in step S2 to obtain a modifying molecular sieve;
step S4: mixing the modifying molecular sieve obtained in step S3 uniformly with water, and then adding a binder thereto to obtain a suspension; and
step S5: molding and drying the suspension to obtain the molecular sieve sound-absorbing material.

6. The method for preparing the sound-absorbing material as described in claim 5, wherein, in step S1, a weight to volume ratio of the molecular sieve to the water is (10 to 30):(150 to 250).

7. The method for preparing the sound-absorbing material as described in claim 5, wherein, in step S2, an ultrasonic device used in the ultrasonic microwave impregnation method is probe ultrasound; a microwave heating temperature of the ultrasonic microwave impregnation method ranges from 60° C. to 90° C.; and ultrasonic impregnation time of the ultrasonic microwave impregnation method ranges from 0.5 h to 2 h.

8. The method for preparing the sound-absorbing material as described in claim 5, wherein, in step S4, a weight ratio of the modifying molecular sieve, the water to the binder is 1: (0.6 to 1.5):(0.02 to 0.10).

9. The method for preparing the sound-absorbing material as described in claim 5, wherein, in step S5, the drying comprises one or more of freeze drying, vacuum drying, and ambient pressure drying.

10. A speaker, comprising a housing with a receiving space, a sound-producing unit arranged in the housing, and a rear cavity enclosed by the sound-producing unit and the housing;
wherein the rear cavity is filled with a sound-absorbing material,
wherein the molecular sieve sound-absorbing material comprises a modifying molecular sieve and a binder, the binder accounts for 2% to 10% by mass of the modifying molecular sieve, the modifying molecular sieve is obtained by performing phosphorus modification on a molecular sieve, a mass ratio of silicon to aluminum in the molecular sieve is (50 to 800):1, and a molar ratio of phosphorus to aluminum in the modifying molecular sieve is (0.1 to 2):1.
